(19) United States
(12) Patent Application Publication
(10) Pub. No.: US 2008/0250979 A1
(43) Pub. Date: Oct. 16, 2008

(54) Clear Coating Composition and Clear Coating Film Formation Method

(75) Inventors: Takashi Irie, Neyagawa-shi (JP); Tsutomu Seta, Neyagawa-shi (JP)

Correspondence Address: CONNOLLY BOVE LODGE & HUTZ LLP, 1875 EYE STREET, N.W., SUITE 1100, WASHINGTON, DC, 20036, US

(73) Assignee: Nippon Paint Co., Ltd., Kita-Ku, Osaka-shi (JP)

(21) Appl. No.: 11/578,516

(22) PCT Filed: Apr. 14, 2005
(86) PCT No.: PCT/JP2005/007575

§ 371 Date: Mar. 3, 2008

(30) Foreign Application Priority Data
Apr. 15, 2004 (JP) 2004-120270

(51) Int. Cl. C09D 133/08

(52) U.S. Cl. 106/287.22

(57) ABSTRACT

It is an object of the present invention to provide a clear coating composition which is desirably controllable for sagging prevention and can form a coating film having various physical properties such as smoothness, good appearance, weather resistance, and water resistance required as a clear coating film and a clear coating film formation method using the coating composition.

A clear coating composition containing a UV curable compound (U-1) having an unsaturated bond, a photopolymerization initiator (U-2), a half ester group-containing acrylic copolymer (A-1), and an epoxy group-containing acrylic copolymer (A-2).

### TECHNICAL FIELD

The invention relates to a clear coating composition and a clear coating film formation method.

### BACKGROUND ART

With respect to coating of an automotive body etc., formation of a top coating film comprising a base coating film and a clear coating film has been carried out widely. Particularly, since the clear coating film forms the outermost layer in the coating film of an automotive body etc., the clear coating film is required to have satisfactory physical properties such as good appearance, water resistance, weather resistance, and the like and a variety of clear coating compositions having such physical properties have been used.

Especially, in order to improve the appearance property, it is desired to sufficiently control the sagging property. In the case of sagging formation, the coating film surface becomes uneven to worsen the smoothness and result in inferior appearance and therefore, it is very important to prevent occurrence of sagging. Particularly, since an automotive body has a complicated shape, it has been extremely difficult to control the smoothness.

For example, with respect to an approximately horizontal face of an object to be coated, it is not desirable to apply a coating composition with an excess viscosity for obtaining the smoothness. In the case a coating film is formed using a coating composition with a low viscosity, a smooth surface is spontaneously to be formed: meanwhile, in the case of using a coating composition with a high viscosity, the coating composition for forming the coating film does not fluidize to make it difficult to form the smooth surface.

On the other hand, with respect to an approximately vertical face, when the coating composition has a low viscosity, it easily flows and drips and therefore, the coating film is required to have a certain viscosity. However, it is not practical to change the types of coating compositions for the approximately horizontal face and approximately vertical face and so that, it is necessary to give aforementioned smoothness of both horizontal and vertical faces by using a single coating composition.

Japanese Kokai Publication Hei-11-300272 discloses a coating film formation method comprising applying a melamine curable coating composition containing an ultraviolet (UV) curable compound to an object to be coated, radiating active energy beam for preliminary curing, and then completely curing the coating film by heating, for controlling the sagging in an intermediate coating composition. However, in this method, since the compatibility of the UV curable compound and a thermosetting binder component is insufficient, in the case such a coating composition is used as the clear coating composition, there occur problems that the transparence is worsened and that appearance is worsened attributed to shrinkage and wrinkles caused by uneven properties in photoreactive portions and heat reactive portions.

Japanese Kokai Publication 2003-245606 discloses a thermosetting coating film formation method using a coating composition containing a photocurable composition, a thermosetting resin composition, a photopolymerization initiator and a photoacid generator, and comprising applying the coating composition, radiating by light to increase the viscosity of the coating film, and curing the coating film by heating. However, in this method, since the photo acid generator is used, it is possible to worsen the properties such as water resistance and weather resistance of the coating film. Therefore, it is required to form a coating film with high water resistance and weather resistance.

### SUMMARY OF THE INVENTION

In view of the above-mentioned state of the art, it is an object of the present invention to provide a clear coating composition which is desirably controllable for sagging prevention and can form a coating film having various physical properties such as smoothness, good appearance, weather resistance, and water resistance required as a clear coating film and a clear coating film formation method using the coating composition.

The invention provides a clear coating composition containing a UV curable compound (U-1) having an unsaturated bond, a photopolymerization initiator (U-2), a half ester group-containing acrylic copolymer (A-1), and an epoxy group-containing acrylic copolymer (A-2).

The invention also provides a clear coating composition containing a UV curable compound (U-1) having an unsaturated bond, a photopolymerization initiator (U-2), a hydroxyl group-containing acrylic resin (B-1), and a polyisocyanate compound (B-2).

The above-mentioned UV curable compound (U-1) having an unsaturated bond is preferably a compound having (meth)acrylate groups.

The invention also provides a clear coating film formation method comprising,

a step (1) of applying the above-mentioned clear coating composition to an object to be coated,

a step (2) of radiating energy beam from an approximately vertical face to the uncured coating film obtained in the step 1, and

a step (3) of curing the coating film by heating the object subjected to the step 2.

The invention also provides a clear coating film formation method comprising,

a step (1) of applying a clear coating composition to an object to be coated,

a step (2) of radiating energy beam from an approximately vertical face to the uncured coating film obtained in the step 1, and

a step (3) of curing the coating film by heating the object subjected to the step 2,

wherein the clear coating composition contains a UV curable compound (U-1) having an unsaturated bond, a photopolymerization initiator (U-2), a component having an active methylene group and/or an active methine group (C-1), and a Michael reaction catalyst (C-2).

The above-mentioned UV curable compound (U-1) having an unsaturated bond is preferably compounds having (meth)acrylate groups.

### DETAILED-DESCRIPTION OF THE INVENTION

Hereinafter, the present invention will be described in detail.

With respect to the clear coating composition and the clear coating film formation method of the invention, it is characteristic that the UV curable compound (U-1) having an unsaturated bond and the photopolymerization initiator (U-2) are used in combination with the thermosetting resin component. When energy beam is radiated to an object to be coated after the coating composition containing the above-mentioned UV curable compound (U-1) having an unsaturated bond and photopolymerization initiator (U-2) is applied to the object, polymerization reaction of the UV curable compound (U-1) having an unsaturated bond is caused by the energy beam radiation to increase the viscosity of the coating film. When the viscosity of the coating film is increased, sagging hardly occurs and consequently, the appearance of the clear coating film can be controlled. Accordingly, even if a solvent remains in the coating film or even if the resin is melted at the time of thermosetting, the fluidity of the coating film can be controlled and sagging can be suppressed.

The thermosetting component to be adopted in the invention is selected as a component which can suppress the sagging problem while reliably keeping various physical properties required for the clear coating composition of the invention. Even among known clear coating compositions, if those which contain an acid, a base, a photoacid generator or the like as a catalytic component are used, the water resistance is deteriorated. On the other hand, in the case of melamine-acrylic type ones, the compatibility with the UV curable compound (U-1) having an unsaturated bond becomes a problem and it is impossible to obtain a coating film with a high transparency. The clear coating composition which will be described below is suitable for forming a clear coating film having good properties without causing such problems as described above even if it is used in combination with the UV curable compound (U-1) having an unsaturated bond.

The above-mentioned UV curable compound (U-1) having an unsaturated bond is preferably a compound having two or more α,β-unsaturated carbonyl groups per one molecule. The above-mentioned α,β-unsaturated carbonyl group is a functional group having a double bond between α-carbon and β-carbon and for example, methacrylate group, acrylate group, maleate group, fumarate group, or the like can be exemplified. If the compound has only one α,β-unsaturated carbonyl group, it is insufficient in the UV curing property and is therefore undesirable. The compound is preferable to have 10 or less α,β-unsaturated carbonyl groups per one molecule and most preferable to have 6 or less.

The above-mentioned UV curable compound (U-1) having an unsaturated bond is not particularly limited and may include (meth)acrylic acid esters of polyols, unsaturated polyester polymers containing α,β-unsaturated dicarboxylic acid such as fumaric acid and maleic acid as an acid component, epoxy polymer (meth)acrylic acid esters, (meth)acryloyl group-containing urethane compounds, α,β-unsaturated carbonyl group-containing acrylic polymers, (meth)acryloyl group-containing polyether polymers, and (meth)acryloyl group-containing silicone oligomers.

The above-mentioned (meth) acrylic acid esters of polyols are esters of polyols having two or more hydroxyl groups and acrylic acid. The polyols having two or more hydroxyl groups may be low molecular weight compounds and polymers. The (meth) acrylic acid esters of polyols are not particularly limited and may include (meth) acrylic acid esters of low molecular weight polyols such as ethylene glycol di(meth)acrylate, neopentyl glycol di(meth)acrylate, trimethylolpropane tri(meth)acrylate, pentaerythritol tetra(meth)acrylate, dipentaerythritol hexa(meth)acrylate, 1,4-cyclohexyldimethanol di(meth)acrylate, 4,4′-isopropylidenedicylochexanol di(meth)acrylate, bis(hydroxymethyl)tricyclo[5,2,1,0]decane di(meth)acrylate, and 1,3,5-tris(2-hydroxyethyl)cyanuric acid tri(meth)acrylate; and (meth)acrylic acid esters of hydroxyl group-containing polymers such as (meth) acrylic acid esters of acrylic polymers having hydroxyl groups, (meth)acrylic acid esters of polyester polyols, (meth)acrylic acid esters of polyether polyols, (meth) acrylic acid esters of epoxy polyols, (meth)acrylic acid esters of polyurethane polyols, and poly(meth)acrylic acid esters of silicone polyols. In this specification, (meth)acrylate means acrylate and methacrylate.

The above-mentioned unsaturated polyester polymers are not particularly limited and may include polymers obtained by condensation polymerization of acid components comprising α,β-unsaturated dicarboxylic acid such as maleic anhydride, fumaric acid, or the like and other polycarboxylic acids to be used based on the necessity, and polyols having two or more hydroxyl groups.

The polyols to be used for the above-mentioned unsaturated polyester polymers are not particularly limited and may include ethylene glycol, diethylene glycol, propylene glycol, tetramethylene glycol, 1,6-hexanediol, neopentyl glycol, trimethylol propane, glycerin, pentaerythritol, 1,4-cyclohexanedimethanol, 4,4′-isopropylidenedicyclohexanol, bis(hydroxymethyl)tricyclo[5,2,1,0]decane, 1,3,5-tris(2-hydroxyethyl)cyanuric acid, isopropylidenebis(3,4-cyclohexanediol) and their adducts such as ethylene oxides, propylene oxides, and/or caprolactones.

Other polycarboxylic acids to be used based on the necessity for the above-mentioned unsaturated polyester polymers are not particularly limited and may include phthalic acid, tetrahydrophthalic acid, hexahydrophthalic acid, methyltetrahydrophthalic acid, isophthalic acid, terephthalic acid, maleic acid, fumaric acid, itaconic acid, adipic acid, azelaic acid, sebacic acid, succinic acid, dodecenylsuccinic acid, and cyclohexane-1,4-dicarboxylic acid.

The above-mentioned epoxy polymer (meth)acrylic acid esters may include polymers obtained by ring-opening addition reaction of bisphenol type or novolak type epoxy polymers and (meth)acrylic acid.

The above-mentioned (meth)acryloyl group-containing urethane compounds may include compounds obtained by addition reaction of polyisocyanate compounds such as isophorone diisocyanate, tolylene diisocyanate, diphenylmethane diisocyanate, hexamethylene diisocyanate, or the like, or their urethane prepolymers with 2-hydroxyethyl (meth)acrylate.

The above-mentioned α,β-unsaturated carbonyl group-containing acrylic polymers may include acrylic polymers having (meth)acrylate groups in side chains and obtained by reaction of acrylic polymers copolymerized with glycidyl (meth)acrylate and (meth)acrylic acid; and acrylic polymers having (meth)acrylate groups in side chains and obtained by reaction of carboxyl group-containing acrylic polymers and epoxy group-containing acrylic monomers such as glycidyl (meth)acrylate.

The above-mentioned (meth)acryloyl group-containing polyether polymers may include compounds obtained by reaction of polyethers having hydroxyl groups at terminals and 2-(meth)acryloyloxyethyl isocyanate.

The above-mentioned (meth)acryloyl group-containing silicone oligomers may include polyorganosiloxanes having 3-(meth)acryloyloxypropyl groups at both terminals.

The above-mentioned UV curable compound (U-1) having an unsaturated bond may have a plurality of hydroxyl groups other than the α,β-unsaturated carboxyl groups. The UV curable compound (U-1) having an unsaturated bond may be used alone or two or more type compounds may be used in combination.

As the UV curable compound (U-1) having an unsaturated bond to be added to the coating composition of the invention, (meth) acrylic acid esters of polyols are preferable since they are excellent in reactivity, weather resistance, compatibility, and gloss.

The number average molecular weight (Mn) of the UV curable compound (U-1) having an unsaturated bond to be added to the coating composition of the invention is preferably in a range of 200 as a lower limit and 10000 as an upper limit. If the number average molecular weight (Mn) is lower than 200, the solvent resistance, water resistance and weather resistance of a coating film may possibly be deteriorated owing to evaporation at the time of thermosetting, decrease of hardness of the coating film, and deterioration of curability of the coating composition. If the number average molecular weight (Mn) is higher than 10000, the viscosity of the UV curable compound (U-1) having an unsaturated bond itself is increased and the amount of an organic solvent to be added to a coating composition diluted at the time of application may possible be increased. The lower limit is more preferably 250 and the upper limit is more preferably 3000.

The equivalent of the double bonds of the UV curable compound (U-1) having an unsaturated bond is preferably in a range of 70 as a lower limit and 1500 as an upper limit. If the equivalent of the double bonds is lower than 70, un-reacted (meth)acrylate groups remain in the obtained coating film to decrease weather resistance of the coating film and make the coating film hard and brittle in some cases. If it exceeds 1500, the crosslinking density of the obtained coating film is lowered to decrease the physical properties and characteristics of the coating film in some cases. In this specification, the equivalent of the double bonds means molecular weight per one double bond. The upper limit is more preferably 1000.

With respect to the above-mentioned UV curable compound (U-1) having an unsaturated bond, in the case the clear coating composition contains a half ester group-containing acrylic copolymer (A-1), an epoxy group-containing acrylic copolymer (A-2), the UV curable compound (U-1) having an unsaturated bond, and photopolymerization initiator (U-2), it is preferable that (U-1)/[(A-1)+(A-2)] (weight ratio) is within a range of (2/98) to (50/50). If the ratio is lower than (2/98), sagging cannot be controlled sufficiently. If it exceeds (50/50), adverse effects on physical properties of the clear coating film may be caused and particularly, the compatibility of the respective components may become insufficient to possibly lose transparency and worsen the appearance. The above-mentioned ratio is more preferably (5/95) to (20/80).

With respect to the UV curable compound (U-1) having an unsaturated bond, in the case the clear coating composition contains a hydroxyl group-containing acrylic resin (B-1), a polyisocyanate compound (B-2), the UV curable compound (U-1) having an unsaturated bond, and photopolymerization initiator (U-2), it is preferable that (U-1)/[(B-1)+(B-2)] (weight ratio) is within a range of (2/98) to (50/50). If the ratio is lower than (2/98), sagging cannot be controlled sufficiently. If it exceeds (50/50), adverse effects on physical properties of the clear coating film may be caused and particularly, the compatibility of the respective components may become insufficient to possibly lose transparency and worsen the appearance. The above-mentioned ratio is more preferably (5/95) to (20/80).

With respect to the UV curable compound (U-1) having an unsaturated bond, in the case the clear coating composition contains a component having an active methylene group and/or active methine group (C-1), the UV curable compound (U-1) having an unsaturated bond, photopolymerization initiator (U-2), and a Michael reaction catalyst (C-2), it is preferable that (U-1)/[(C-1)+(C-2)] (weight ratio) is within a range of (2/98) to (50/50). If the ratio is lower than (2/98), sagging cannot be controlled sufficiently. If it exceeds (50/50), adverse effects on physical properties of the clear coating film may be caused and particularly, the compatibility of the respective components may become insufficient to possibly lose transparency and worsen the appearance. The above-mentioned ratio is more preferably (5/95) to (20/80).

The coating composition containing a curable binder to be used in the invention further contains a photopolymerization initiator (U-2). As the photopolymerization initiator (U-2), conventionally known ones may be used and examples of the initiator are benzoins and benzoin alkyl ethers such as benzoin, benzoin methyl ether, benzoin ethyl ether, and benzoin propyl ether; acetophenones such as acetophenone, 2,2-dimethoxy-2-phenylacetophenone, 2,2-diethoxy-2-phenylacetophenone, and 1,1-dichloroacetophenone; aminoacetophenones such as 2-methyl-1-[4-(methylthio)phenyl]-2-morpholinopropanone-1,2-benzyl-2-dimethylamino-1-(4-morpholinophenyl)butanone-1, and N,N-dimethylaminoacetophenone; anthraquinones such as 2-methylanthraquinone, 2-ethylanthraquinone, 2-tert-butylanthraquinone, and 1-chloroanthraquinone; thioxanthones such as 2,4-dimethylthioxanthone, 2,4-diethylthioxanthone, 2-chlorothioxanthone, and 2,4-diisopropylthioxanthone; ketals such as acetophenone dimethyl ketal and benzyl dimethyl ketal; benzophenones and xanthones such as benzophenone and 4,4′-bisdiethylaminobenzophenone; 2,4,6-trimethylbenzoyldiphenylphosphine oxide, aromatic iodoniums, sulfoniums, and diazoniums, and polysilane compounds. Two or more of these compounds may be used in combination and further a photopolymerization initiator aid such as tertiary amines such as triethanolamine and ethyl dimethylaminobenzoate may be used in combination.

The addition amount of the photopolymerization initiator (U-2) is not particularly limited and may properly be set depending on the reaction ratio of the thermosetting and photocuring. Also, it may be adjusted depending on the degree of the required weather resistance and the types and amounts of additives such as a UV absorption component or the like. Generally, the addition amount of the photopolymerization initiator (U-2) in the coating composition containing a curable binder to be used in the invention is, for example, 0.01 to 10% by weight to the above-mentioned component (U-1).

In the invention, the UV curable compound (U-1) having an unsaturated bond is used in combination with other thermosetting resin composition. To say more specifically, it is used in combination with an acid-epoxy-curable resin composition, isocyanate curable resin composition, and Michael curable resin composition. Hereinafter, these coating compositions will be explained more specifically.

A first invention is a clear coating composition containing the above-mentioned UV curable compound (U-1) having an unsaturated bond and an acid-epoxy curable resin composition in combination and more specifically the composition contains a half ester group-containing acrylic copolymer (A-1), an epoxy group-containing acrylic copolymer (A-2), the UV curable compound (U-1) having an unsaturated bond, and a photopolymerization initiator (U-2).

The above-mentioned half ester group-containing acrylic copolymer (A-1) is an acrylic copolymer having half ester groups formed by half-esterification of acid anhydride groups with hydroxyl groups in a molecule. The half ester groups should be formed by reaction of carboxyl groups and carboxylate groups by heating so as to produce acid anhydride in the half ester group-containing acrylic copolymer. The above-mentioned half ester group-containing acrylic copolymer is not particularly limited and may include a copolymer (A-1-i) obtained by obtaining a copolymer by copolymerizing a monomer composition containing an acid anhydride group-containing radical polymerizable monomer (a-1) and another radical polymerizable monomer (a-2) and then half-esterifying the above-mentioned acid anhydride group with a low molecular weight alcohol compound and a copolymer (A-1-ii) of the half ester group-containing polymerizable monomer (a-3) and another radical polymerizable monomer (a-4).

The acid anhydride group-containing radical polymerizable monomer (a-1) to be used for polymerization of the half ester group-containing acrylic copolymer (A-1-i) is not particularly limited when it is a radical polymerizable monomer having an acid anhydride group and examples are itaconic acid anhydride, maleic anhydride, and citraconic anhydride.

Another radical polymerizable monomer (a-2) to be used for polymerization of the half ester group-containing acrylic copolymer (A-1-i) is not particularly limited and examples are styrenes such as styrene and α-methylstyrene; acrylic acid esters such as methyl acrylate, ethyl acrylate, propyl acrylate, n-, iso-, and tert-butyl acrylate, 2-ethylhexyl acrylate, and lauryl acrylate; methacrylic acid esters such as methyl methacrylate, ethylmethacrylate, propyl methacrylate, n-, iso-, and tert-butyl methacrylate, 2-ethylhexyl methacrylate, and lauryl methacrylate; and amides such as acrylamide and methacrylamide. They may be used alone and two or more of them may be used in combination.

With respect to the copolymer composition in the case of obtaining the copolymer from the acid anhydride group-containing radical polymerizable monomer (a-1) and another radical polymerizable monomer (a-2), the acid anhydride group-containing radical polymerizable monomer (a-1) is preferable to be added in a ratio of 10% by weight as a lower limit and 40% by weight as an upper limit in the total weight of the monomer composition. The lower limit is more preferably 15% by weight and the upper limit is more preferably 30% by weight.

A copolymerization method of the half ester group-containing acrylic copolymer (A-1-i) is not particularly limited and conventional solution polymerization methods such as radical polymerization can be exemplified. The number average molecular weight (Mn) of the copolymer is preferably in a range of 500 as a lower limit and 10000 as an upper limit. The lower limit is more preferably 1000 and the upper limit is more preferably 8000. If the number average molecular weight (Mn) is lower than 500, the curability of the coating composition is insufficient and if it exceeds 10000, the viscosity of the copolymer is increased to make it difficult to obtain a thermosetting coating composition with high solids and therefore, it is not preferable. In this specification, the number average molecular weight (Mn) is calculated by conversion into polystyrene measured by GPC (gel permeation chromatography).

The radical polymerization initiator to be used for the above-mentioned polymerization reaction is not particularly limited and examples are tert-butylperoxy-2-ethylhexanoate, dimethyl-2,2′-azobisisobutylate, and the like. They may be used alone or two or more of them may be used in combination. The radical polymerization initiator is preferable to be used in a ratio of 3% by weight as a lower limit and 15% by weight as an upper limit in the total amount of the above-mentioned monomers. The above-mentioned copolymer may be mixed with a chain transfer agent as an additive.

With respect to the acid anhydride group in the above-mentioned copolymer, two or more acid anhydride groups are preferable to be contained in one molecule. If it is less than 2, the curability is insufficient. It is more preferable to contain 2 to 15 acid anhydride groups.

The above-mentioned half-esterification is carried out after the above-mentioned copolymer is obtained. A half esterification agent to be used for the half-esterification of the above-mentioned acid anhydride group is not particularly limited when it is a low molecular weight alcohol compound and examples are methanol, ethanol, n-propanol, isopropanol, n-butanol, isobutanol, tert-butanol, methylcellosolve, ethylcellosolve, dimethylaminoethanol, diethylaminoethanol, acetol, allyl alcohol, and propargyl alcohol. They may be used alone and two or more of them may be used in combination. Among them, acetol, allyl alcohol, propargyl alcohol, and methanol are more preferable.

The reaction method of the half esterification is not particularly limited and, for example, the method may be carried out at a temperature from a room temperature to 120° C. in the presence of a catalyst according to a conventional method. The catalyst is not particularly limited and examples are tertiary amines such as triethylamine and tributylamine; and quaternary ammonium salts such as benzyltrimethylammonium chloride, benzyltrimethylammonium bromide, benzyltributylammonium chloride, and benzyltributylammonium bromide. They may be used alone and two or more of them may be used in combination.

In the above-mentioned half esterification reaction, the acid anhydride group-containing polymer and monoalcohol are to be reacted at a mole ratio of the acid anhydride groups and hydroxyl group in a range of (1/10) to (1/1), preferably (1/5) to (1/1.3), and more preferably (1/2) to (1/1). If the ratio is lower than (1/10), the alcohol is so excess as to cause blister at the time of curing in some cases. If it exceeds (1/1), un-reacted anhydride groups remain to worsen the storage stability in some cases and therefore it is not preferable.

The half ester group-containing radical polymerizable monomer (a-3) to be used for polymerization of the half ester group-containing acrylic copolymer (A-1-ii) is not particularly limited and those obtained by half esterification of the acid anhydride group-containing radical polymerizable monomer (a-1) and low molecular weight alcohol compound can be exemplified.

The half esterification reaction can be carried out by a method similar to the half esterification reaction in the case of the above-mentioned polymer (A-1-i). The reaction of the compounds is preferable to be carried out at a mole ratio of the hydroxyl groups and acid anhydride groups in a range of (1/0.5) to (1/1.0). In the mole ratio, if the ratio of the acid anhydride groups is lower than 1/0.5, a problem of insufficient curability sometimes may occurs and if the ratio of the acid anhydride groups exceeds (1/1.0), the un-reacted acid anhydride groups remain to worsen the storage stability in some cases.

Another radical polymerizable monomer (a-4) is not particularly limited and examples are the radical polymerizable monomers which can be used as the above-mentioned (a-2).

In the case a copolymer is obtained by reaction of the above-mentioned half ester group-containing radical polymerizable monomer (a-3) and another radical polymerizable monomer (a-4), the half ester group-containing radical polymerizable monomer (a-3) is preferable to be contained in an amount range of 3% by weight as a lower limit and 30% by weight as an upper limit in the monomer composition to be used for polymerization. The lower limit is more preferably 5% by weight and the upper limit is more preferably 20% by weight.

The above-mentioned copolymerization method is not particularly limited and, for example, a conventional solution polymerization such as radical polymerization can be exemplified. The number average molecular weight (Mn) of the copolymer is preferably in a range of 500 as a lower limit and 10000 as an upper limit. The lower limit is more preferably 1000 and the upper limit is more preferably 8000. If the number average molecular weight (Mn) is lower than 500, the curability of the coating composition is insufficient and if it exceeds 10000, the viscosity of the copolymer is increased to make it difficult to obtain a thermosetting coating composition with high solids in some cases. The radical polymerization initiator to be used for the polymerization reaction is not particularly limited and radical polymerization initiators to be used for polymerization of the polymer (A-1-i) can be exemplified.

It is preferable that two or more acid anhydride groups exist in every one molecule of the copolymer. If it is less than 2 groups, the curability is adversely insufficient. It is more preferable that 15 or less groups exist in every one molecule.

The epoxy group-containing acrylic copolymer (A-2) is an acrylic polymer having an epoxy group and is obtained by copolymerization of a monomer composition containing an epoxy group-containing radical polymerizable monomer (a-5) and another radical polymerizable monomer (a-6).

The epoxy group-containing radical polymerizable monomer (a-5) is not particularly limited and glycidyl (meth)acrylate, 3,4-epoxycyclohexanylmethyl methacrylate, and the like can be exemplified. They may be used alone and two or more of them may be used in combination.

Another radical polymerizable monomer (a-6) is not particularly limited and for example, the monomers exemplified for another radical polymerizable monomer (a-2) can be used. The above-mentioned radical polymerizable monomer (a-6) is preferable to have a hydroxyl group-containing radical polymerizable monomer. The hydroxyl group-containing radical polymerizable monomer is not particularly limited and examples are 2-hydroxyethyl (meth)acrylate, 4-hydroxybutyl (meth)acrylate, Placcel FM-1 (trade name, manufactured by Daicel Chem. Ind., Ltd.), Placcel FA-1 (trade name, manufactured by Daicel Chem. Ind., Ltd.), and the like. Existence of the hydroxyl group-containing radical polymerizable monomer gives good curability of the coating composition.

The above-mentioned copolymerization method is not particularly limited and a solution polymerization method such as radical polymerization can be exemplified. The number average molecular weight (Mn) of the copolymer is preferably in a range of 500 as a lower limit and 10000 as an upper limit. The lower limit is more preferably 1000 and the upper limit is more preferably 8000. If the number average molecular weight is lower than 500, the curability of the coating composition is insufficient and if it exceeds 10000, the viscosity of the copolymer is increased to make it difficult to obtain a thermosetting coating composition with high solids. The radical polymerization initiators to be used for the polymerization reaction may be those similar to the initiators to be used in the case of the reaction of the half ester group-containing acrylic copolymer (A-1-i).

The epoxy group-containing acrylic copolymer (A-2) is preferable to be obtained from a monomer composition containing an epoxy group-containing radical polymerizable monomer (a-5) in a range of 30% by weight as a lower limit and 70% by weight as an upper limit and another radical polymerizable monomer (a-6) in a range of 30% by weight as a lower limit and 70% by weight as an upper limit. The above-mentioned monomer composition is preferable to contain the hydroxyl group-containing radical polymerizable monomer in a range of 10% by weight as a lower limit and 50% by weight as an upper limit. In the case the hydroxyl group-containing radical polymerizable monomer is used as a monomer, it is preferable to contain it in a range of 10% by weight as a lower limit and 50% by weight as an upper limit in the raw material monomer composition at the time of the reaction of the epoxy group-containing acrylic copolymer.

The epoxy group-containing acrylic copolymer (A-2) is preferable to be contained in a range of 30% by weight as a lower limit and 60% by weight as an upper limit in the total amount of the polymer solids contained in the clear coating composition. If it is out of the range, there occurs a problem that the curability is insufficient and therefore it is undesirable. The lower limit is more preferably 20% by weight and even more preferably 30% by weight. The upper limit is more preferably 50% by weight and even more preferably 45% by weight.

The clear coating composition of the first invention containing the half ester group-containing acrylic copolymer (A-1) and epoxy group-containing acrylic copolymer (A-2) is preferable to further contain a carboxyl group-containing polymer (A-3).

The above-mentioned carboxyl group-containing polymer (A-3) is a polymer containing at least one carboxyl group in a molecule. Examples of the carboxyl group-containing polymer (A-3) are carboxyl group-containing polyester polymers (A-3-i) and carboxyl group-containing acrylic polymers (A-3-ii). The carboxyl group-containing polymer (A-3) may contain either one or both of the carboxyl group-containing polyester polymers (A-3-i) and carboxyl group-containing acrylic polymers (A-3-ii).

The carboxyl group-containing polyester polymers (A-3-i) to be used as the carboxyl group-containing polymer of the invention means polyester polymers having a carboxyl group in a molecule. The carboxyl group is more preferable to be formed by addition reaction of acid anhydride group and hydroxyl group.

As polymers obtained by adding the carboxyl group-containing polyester polymers (A-3-i), polyester polyols obtained by chain extension reaction by adding a lactone compound (a-8) to a low molecular weight polyhydric alcohol (a-7) and polymers obtained by adding an acid anhydride group-containing compound (a-9) are preferable to be used.

Since the carboxyl group-containing polyester polymers (A-3-i) obtained by the above-mentioned reaction has a sharp molecular weight distribution, the clear coating composition of the invention can have high solids ratio (high solid) and gives a coating film excellent in the weather resistance and water resistance and at the same time excellent in chipping resistance, surface smoothness and appearance and therefore it is preferable.

The above-mentioned low molecular weight polyhydric alcohol (a-7) is not particularly limited and those having at least three hydroxyl groups in one molecule are preferable and examples are trimethylolpropane, trimethylolethane, 1,2,4-butanetriol, di(trimethylolpropane), pentaerythritol, dipentaerythritol, glycerin and the like. They may be used alone and two or more of them may be used in combination.

The above-mentioned lactone compound (a-8) is not particularly limited if it is a lactone compound capable of causing ring-opening addition reaction of the above-mentioned low molecular weight polyhydric alcohol compound. Since it easily causes the ring-opening addition, the lactone compound (a-8) is preferable to have 4 to 7 carbon atoms.

The above-mentioned lactone compound (a-8) is not particularly limited and examples are ε-caprolactone, γ-caprolactone, γ-valerolactone, δ-valerolactone, and γ-butyrolactone. They may be used alone and two or more of them may be used in combination. Among them, ε-caprolactone and δ-valerolactone are more preferable and in terms of the reactivity, ε-caprolactone is even more preferable.

The above-mentioned chain extension reaction may be carried out in the conditions same as those of common ring opening addition reaction. For example, in a proper solvent or with no solvent, the above-mentioned polyester polyol in which the low molecular weight polyhydric alcohol (a-7) is chain-extended is obtained by reaction at a temperature of 80 to 200° C. within 5 hours. In the above-mentioned reaction, a tin type catalyst etc. may be used.

At the time of the above-mentioned chain extension reaction, the ratio of the hydroxyl groups of the low molecular weight polyhydric alcohol (a-7) and the lactone compound (a-8) is preferable to be adjusted as 0.2 as a lower limit and 10 as an upper limit of the lactone compound (a-8) to 1 hydroxyl group of the low molecular weight polyhydric alcohol (a-7). If the ratio is low than 0.2, the coating film becomes hard and impact resistance of the coating film is deteriorated and if it exceeds 10, the hardness of the coating film is decreased. The lower limit is more preferably 0.25 and even more preferably 0.3. The upper limit is more preferably 5 and even more preferably 3.

The above-mentioned acid anhydride group-containing compound (a-9) is not particularly limited and examples are phthalic anhydride, tetrahydrophthalic anhydride, hexahydrophthalic anhydride, 4-methylhexahydrophthalic anhydride, trimellitic anhydride, and succinic anhydride. The acid anhydride group-containing compound (a-9) is more preferably compounds having 8 to 12 carbon atoms and hexahydrophthalic anhydride, 4-methylhexahydrophthalic anhydride, or trimellitic anhydride is more preferable. They may be used alone or two or more of them may be used in combination.

The addition reaction method of the above-mentioned polyester polyol and the acid anhydride group-containing compound (a-9) is not particularly limited and may be carried out in the reaction conditions similar to those half-esterification for obtaining the above-mentioned half ester group-containing acrylic copolymer (A-1-i).

In the above-mentioned addition reaction, the mole ratio of the acid anhydride group-containing compound (a-9) to the hydroxyl groups of the low molecular weight polyhydric alcohol (a-7) is preferably 0.2 as a lower limit and 1.0 as an upper limit. If the mole ratio is lower than 0.2, the curability of the coating composition is insufficient in some cases. The lower limit of the mole ratio is more preferably 0.5 and the upper limit of the mole ratio is more preferably 0.9.

It is no need to modify all of the hydroxyl groups of the polyester polyol to carboxyl groups and some hydroxyl groups may be left. That is, the carboxyl group-containing polyester polymer (A-3-i) having hydroxyl groups provides the carboxyl groups and hydroxyl groups to the surface of the coating film at the same time, so that excellent adhesion property can be obtained in the case, for example, of re-coating as compared with that in the case of using carboxyl group-containing polyester polymer (A-3-i) not having hydroxyl group.

The above-mentioned carboxyl group-containing polyester polymer (A-3-i) is preferable to have an acid value in a range of 50 mgKOH/g as a lower limit and 350 mgKOH/g as an upper limit. If the acid value is lower than 50 mgKOH/g, the curability of the coating composition is insufficient in some cases and if the acid value exceeds 350 mgKOH/g, the viscosity of the carboxyl group-containing polyester polymer (A-3-i) is increased so high as to make it difficult to obtain a thermosetting coating composition with high solids. The lower limit is more preferably 100 mgKOH/g and even more preferably 150 mgKOH/g. The upper limit is more preferably 300 mgKOH/g and even more preferably 250 mgKOH/g.

The above-mentioned carboxyl group-containing polyester polymer (A-3-i) is preferable to have a number average molecular weight (Mn) in a range of 400 as a lower limit and 3500 as an upper limit. If the number average molecular weight is lower than 400, the curability of the coating composition or water resistance of the coating film is insufficient in some cases and if the molecular weight exceeds 3500, the viscosity of the carboxyl group-containing polyester polymer (A-3-i) is increased so high as to be hard to use and make it difficult to obtain a thermosetting coating composition with high solids. The lower limit is more preferably 500 and even more preferably 700. The upper limit is more preferably 2500 and even more preferably 2000.

The above-mentioned carboxyl group-containing polyester polymer (A-3-i) is preferable to have a [weight average molecular weight (Mw)]/[number average molecular weight (Mn)] ratio not higher than 1.8. If the [weight average molecular weight (Mw)]/[number average molecular weight (Mn)] ratio exceeds 1.8, the water resistance and weather resistance of the coating film is deteriorated in some cases. The [weight average molecular weight (Mw)]/[number average molecular weight (Mn)] ratio is more preferably 1.5 or lower and even more preferably 1.35 or lower.

If the carboxyl group-containing polyester polymer (A-3-i) has hydroxyl groups, the carboxyl group-containing polyester polymer (A-3-i) is preferable to have a hydroxy value in a range of 150 mgKOH/g or lower. If the hydroxy value exceeds 150 mgKOH/g, the water resistance of the coating film is deteriorated in some cases. It is preferably in a range of 5 mgKOH/g as lower limit and 100 mgKOH/g as an upper limit. The lower limit is more preferably 10 mgKOH/g and the upper limit is more preferably 80 mgKOH/g.

The carboxyl group-containing polyester polymer (A-3-i) is preferable to be contained at a ratio in a range of 5% by weight as a lower limit and 70% by weight as an upper limit in the entire polymer solids contained in the clear coating composition. If it is lower than 5% by weight, it is difficult to obtain a thermosetting coating composition with high solids and if it exceeds 70% by weight, the weather resistance of the coating film is deteriorated and therefore, it is not desirable. The lower limit is more preferably 10% by weight and even more preferably 15% by weight. The upper limit is more preferably 50% by weight and even more preferably 40% by weight.

The above-mentioned carboxyl group-containing acrylic polymers (A-3-ii) is a polymer having at least one carboxyl group and the carboxyl group is more preferable to be derived by addition reaction of acid anhydride group and hydroxyl group. The carboxyl group in the carboxyl group-containing acrylic polymers (A-3-ii) is similar to the half ester group of the half ester group-containing acrylic copolymer (A-1) at a point that the carboxyl group is formed by the addition reaction of the acid anhydride group and hydroxyl group but dissimilar to the half ester group of the half ester group-containing acrylic copolymer (A-1) at a point that no acid anhydride group is formed even by heating at the time of curing reaction.

The carboxyl group-containing acrylic polymer (A-3-ii) is preferably a copolymer obtained by reaction of the above-mentioned carboxyl group-containing radical polymerizable monomer (a-10) and another radical polymerizable monomer (a-11).

As the carboxyl group-containing radical polymerizable monomer (a-10), monomers obtained by reaction of a hydroxyl group-containing radical polymerizable monomer and the above-mentioned acid anhydride group-containing compound (a-9) can be exemplified. The hydroxyl group-containing radical polymerizable monomer is not particularly limited and examples are 2-hydroxyethyl (meth)acrylate, 4-hydroxybutyl (meth)acrylate, Placcel FM-1 (tradename, manufactured by Daicel Chem. Ind., Ltd.), Placcel FA-1 (trade name, manufactured by Daicel Chem. Ind., Ltd.), and the like.

The above-mentioned addition reaction can be carried out by a similar method to that of the half esterification reaction in the above-mentioned polymer. The reaction of the compound is preferably carried out at a mole ratio of the hydroxyl group and the acid anhydride group in a range of (1/0.5) to (1/1.0). If the ratio of the acid anhydride group is lower than 1/0.5, a problem of insufficient curing occurs and if the ratio of the acid anhydride group exceeds (1/1.0), un-reacted acid anhydride group remains to worsen the storage stability.

Above-mentioned another radical polymerizable monomer (a-11) is not particularly limited and monomers usable for the above-mentioned (a-2) can be used.

In the case a copolymer is obtained by reaction of the carboxyl group-containing radical polymerizable monomer (a-10) and the above-mentioned another radical polymerizable monomer (a-11), the carboxyl group-containing radical polymerizable monomer (a-10) is preferable to be added in an amount of 10% by weight as a lower limit and 40% by weight as an upper limit in the entire monomer weight. The lower limit is more preferably 15% by weight and the upper limit is 30% by weight.

The copolymerization method is not particularly limited and a conventional method of solution polymerization such as radical polymerization can be exemplified. The number average molecular weight (Mn) of the copolymer is preferably in a range of 500 as a lower limit and 10000 as an upper limit. The lower limit is more preferably 1000 and the upper limit is more preferably 8000. If the number average molecular weight (Mn) is lower than 500, the curability of the coating composition is insufficient and if it exceeds 10000, the viscosity of the copolymer is increased to make it difficult to obtain a thermosetting coating composition with high solids. In this specification, the number average molecular weight (Mn) is calculated by conversion into polystyrene measured by GPC (gel permeation chromatography). A radical polymerization initiator to be used for the polymerization reaction is not particularly limited and those which can be used in the polymerization of the above-mentioned polymer (A-1-i) can be exemplified.

The copolymer comprises at least two or more carboxyl groups in a molecule. If the carboxyl groups are less than 2, the curability is insufficient. The number of the groups is preferably 2 to 15.

The carboxyl group-containing acrylic polymers (A-3-ii) is preferable to be contained in an amount of 5% by weight as a lower limit and 50% by weight as an upper limit in the entire polymer solids weight. If it is less than 5% by weight, it becomes difficult to obtain a thermosetting coating composition with high solids and if it exceeds 50% by weight, the weather resistance of the coating film is decreased and therefore it is not preferable. The lower limit is more preferably 10% by weight. The upper limit is more preferably 40% by weight and even more preferably 30% by weight.

The coating composition of the first invention may be produced by adding a UV curable compound (U-1) having an unsaturated bond and a photopolymerization initiator (U-2) to a commercialized clear coating composition containing the half ester group-containing acrylic copolymer (A-1) and epoxy group-containing acrylic copolymer (A-2). The commercialized clear coating composition containing the half ester group-containing acrylic copolymer (A-1) and epoxy group-containing acrylic copolymer (A-2) is not particularly limited and for example, Mac Flow 0-1810 Clear manufactured by Nippon Paint Co., Ltd. or the like can be exemplified.

A second invention adopts the above-mentioned UV curable compound (U-1) having an unsaturated bond in combination with an isocyanate curable resin composition and specifically provides a clear coating composition containing a hydroxyl group-containing acrylic resin (B-1), a polyisocyanate compound (B-2), the UV curable compound (U-1) having an unsaturated bond, and a photopolymerization initiator (U-2).

The above-mentioned hydroxyl group-containing acrylic resin (B-1) is an acrylic resin having hydroxyl group and a polymer obtained by copolymerization of a monomer composition containing hydroxyl group-containing radical polymerizable monomer and another radical polymerizable monomer. The above-mentioned hydroxyl group-containing radical polymerizable monomer is not particularly limited and examples are 2-hydroxyethyl (meth)acrylate, 4-hydroxybutyl (meth)acrylate, Placcel FM-1 (trade name, manufactured by Daicel Chem. Ind., Ltd.), Placcel FA-1 (trade name, manufactured by Daicel Chem. Ind., Ltd.), and the like. Another radical polymerizable monomer is not particularly limited and styrenes such as styrene and α-methylstyrene; acrylic acid esters such as methyl acrylate, ethyl acrylate, propyl acrylate, n-, iso-, and tert-butyl acrylate, 2-ethylhexyl acrylate, and lauryl acrylate; methacrylic acid esters such as methyl methacrylate, ethyl methacrylate, propyl methacrylate, n-, iso-, and tert-butyl methacrylate, 2-ethylhexyl methacrylate, and lauryl methacrylate; and amides such as acrylamide and methacrylamide. The hydroxyl group-containing acrylic resin (B-1) can be obtained by a conventional polymerization reaction of the above-mentioned monomers.

The hydroxy value of the hydroxyl group-containing acrylic resin (B-1) is preferable to be in a range of 20 as a lower limit and 200 as an upper limit. If it exceeds 200, the water resistance of the coating film is decreased and if it is lower than 20, the curability of the coating film is deteriorated. The lower limit is more preferably 30 and the upper limit is more preferably 180.

The number average molecular weight of the hydroxyl group-containing acrylic resin (B-1) is preferably in a range of 1000 as a lower limit and 20000 as an upper limit. If the number average molecular weight is lower than 1000, the workability and curability are insufficient and if it exceeds 20000, the non-volatile component is so low as to rather worsen the workability at the time of application. The lower limit is more preferably 2000 and the upper limit is more preferably 15000. In this specification, the number average molecular weight (Mn) is determined by GPC method using polystyrene polymer as the standard.

The hydroxyl group-containing acrylic resin (B-1) is preferable to have an acid value in a range of 2 mgKOH/g as a lower limit and 30 mgKOH/g as an upper limit. If the acid value exceeds the upper limit, the water resistance of the coating film is deteriorated and if it is lower than the lower limit, the curability of the coating film is deteriorated. The lower limit is more preferably 3 mgKOH/g and the upper limit is more preferably 25 mgKOH/g.

The polyisocyanate compound (B-2) is not particularly limited and examples are aliphatic isocyanates such as trimethylene diisocyanate, tetramethylene diisocyanate, pentamethylene diisocyanate, hexamethylenediisocyanate (HDI), and trimethylhexamethylene diisocyanate; alicyclic isocyanates such as 1,3-cyclopentane diisocyanate, 1,4-cyclehexane diisocyanate, 1,2-cyclohexanediisocyanate; aromatic isocyanates such as xylylene diisocyanate (XDI), 2,4-tolylene diisocyanate (TDI), and 2,6-tolyelne diisocyanate; alicyclic isocyanates such as isophorone diisocyanate (IPDI) and norbornane methyl diisocyanate, and their polymers and mixtures such as biurate bodies and nurate bodies.

In the case a block isocyanate compound is used in place of the above-mentioned polyisocyanate compound (B-2), in terms of the sagging and surface appearance, a clear coating composition is inferior as compared with the clear coating composition of the invention using the polyisocyanate compound (B-2) which is not blocked. The cause of such difference is not made clear but since if the block isocyanate compound is used, the polyisocyanate compound produced by the de-block reaction causes curing reaction and therefore, it can be assumed that the curing reaction in the thermosetting step is delayed to an extent of the de-block reaction execution and that the blocking agent isolated by the de-block reaction works as a solvent to decrease the viscosity and make it easy to cause sagging.

As described above, in the invention, it is required to use a polyisocyanate compound which is not blocked in place of a block polyisocyanate and therefore the above-mentioned acrylic isocyanate curing type clear coating composition is required to be a two-component clear coating composition. Although the UV curable compound (U-1) and the photopolymerization initiator (U-2) may be added to a resin solution or to a curing agent solution, they are preferable to be added to the resin solution.

The clear coating composition is preferable to contain a hydroxyl group-containing coating film-formable resin. The mixing ratio of the isocyanate compound to the coating film-formable resin may be variable depending on the applications and in the clear coating composition in the invention, it is preferable so as to adjust the equivalent ratio (NCO/OH) of the isocyanate group (NCO) and the hydroxyl group (OH) in a range of 0.5 as a lower limit and 1.7 as an upper limit. If the content is lower than the lower limit, the curability is insufficient and if it exceeds the upper limit, the cured coating film becomes too rigid and brittle. The lower limit is more preferably 0.7 and the upper limit is more preferably 1.5.

The coating composition of the second invention may be produced by adding the UV curable compound (U-1) having an unsaturated bond and the photopolymerization initiator (U-2) to a commercialized clear coating composition containing the hydroxyl group-containing acrylic resin (B-1) and polyisocyanate compound (B-2). The commercialized clear coating composition containing the hydroxyl group-containing acrylic resin (B-1) and polyisocyanate compound (B-2) is not particularly limited and for example, Polyure Excel O-1100 Clear manufactured by Nippon Paint Co., Ltd. or the like can be exemplified.

A third invention adopts a UV curable compound (U-1) having an unsaturated bond in a Michael curable resin composition and more specifically provides a clear coating composition containing a component having an active methylene group and/or active methine group (C-1), the UV curable compound (U-1) having an unsaturated bond, the photopolymerization initiator (U-2), and a Michael reaction catalyst (C-2). In the Michael curable resin composition, the UV curable compound (U-1) having an unsaturated bond is a component contributing to the Michael curing reaction in the thermosetting and although the composition of the clear coating composition is known, it has not been known so far that the composition is used for a specified coating film formation method of the invention.

The component having an active methylene group and/or active methine group (C-1) is preferable to have two or more active methylene groups and/or active methine groups per one molecule. Examples of such a component are reaction products of polyols with carboxylic acid compounds having active methylene group and/or active methine group or carboxylic acid esters having active methylene group and/or active methine group. Examples of the carboxylic acid compounds or the carboxylic acid esters having active methylene group are specifically acetoacetic acid, malonic acid, cyanoacetic acid, and their derivatives and esters. Also, examples of the carboxylic acid compounds and the carboxylic acid esters having active methine group are specifically methanetricarboxylic acid and its derivatives and their alkyl esters as described in EP No. 0310011. The active methylene group is preferably methylene group sandwiched between two carbonyl groups and being in an electron excess state owing to the carbonyl groups and thus easy to produce carboanion by releasing the proton. The active methine group is preferably methine group surrounded among three carbonyl groups and being in an electron excess state owing to the carbonyl groups and thus easy to produce carboanion by releasing the proton.

Examples of the above-mentioned polyol are those having two or more hydroxyl groups per one molecule and practical examples are ethylene glycol, diethylene glycol, propylene glycol, tetramethylene glycol, 1,6-hexanediol, neopentyl glycol, trimethylol propane, glycerin, pentaerythritol, 1,4-cyclohexanedimethanol, 4,4′-isopropylidenedicyclohexanol, bis(hydroxymethyl)tricyclo[5,2,1,0]decane, 1,3,5-tris(2-hydroxyethyl)cyanuric acid, isopropylidenebis(3,4-cyclohexanediol) and their adducts such as ethylene oxides, propylene oxides, or caprolactones. Further, as the polyol, acrylic polyols, polyester polyols, polyether polyols, epoxy polyols, polyurethane polyols, and silicone polyols etc. can be exemplified.

The component having active methylene group and/or active methine group (C-1) may be polyester resin having two or more active methylene groups per one molecule, which is obtained by condensation polymerization of the above-mentioned polyol with malonic acid or a malonic acid ester.

Further, as the component (C-1), reaction products of polyamine compounds and diketenes can be exemplified. Examples of the polyamine compounds are those having two or more amino groups per one molecule and may include ethylenediamine, 1,3-diaminopropane, 1,4-diaminobutane, 1,6-hexanediamine, 1,12-diaminododecane, 1,2-diaminocyclohexane, phenylenediamine, piperazine, 2,6-diaminotoluene, diethyltoluenediamine, N,N′-bis(2-aminopropyl)ethylenediamine, and N,N′-bis(3-aminopropyl)-1,3-propanediamine.

Further as the component (C-1), acrylic resins having active methylene group and/or active methine group can be exemplified. Such a resin can be obtained specifically by copolymerization of an acrylic monomer having active methylene group and/or active methine group in a molecule with an acrylic monomer not having active methylene group and/or active methine group and/or a non-acrylic monomer. Examples of the acrylic monomer having active methylene group and/or active methine group in a molecule are 2-acetoacetoxyethyl (meth)acrylate, 2-cyanoacetoxyethyl (meth)acrylate, N-(2-cyanoacetoxyethyl) (meth)acrylamide, N-(2-propionylacetoxybutyl) (meth)acrylamide, N-4-(acetoacetoxymethyl)benzyl (meth)acrylamide, N-(2-acetoacetoamidoethyl) (meth)acrylamide, and acrylic monomers having malonic acid esters in side chains as disclosed in Japanese Kokai Publication Hei-9-309931. Examples of the acrylic monomer not having active methylene group and/or active methine group are (meth) acrylic acid of methyl, ethyl, propyl, n-butyl, isobutyl, tert-butyl, 2-ethylhexyl, lauryl, phenyl, benzyl, 2-hydroxyethyl, 2-hydroxypropyl, 4-hydroxybutyl, an adduct of 2-hydroxyethyl (meth)acrylate and caprolactone, glycidyl (meth)acrylate, (meth)acrylamide, methylenebis(meth)acrylamide, and acrylonitrile. Examples of the non-acrylic monomer are styrene, α-methylstyrene, itaconic acid, maleic acid, and vinyl acetate.

As the component (C-1), reaction products of isocyanate compounds and the carboxylic acid compounds having active methylene group and/or the carboxylic acid esters having active methylene group can be exemplified. Practical examples of the isocyanate compound are tolylene diisocyanate, 4,4′-diphenylmethane diisocyanate, xylylene diisocyanate, hexamethylene diisocyanate, lysine diisocyanate, 4,4′-methylenebis(cyclohexylisocyanate), methylcyclohexane diisocyanate, 1,3-(isocyanatomethyl)cyclohexane, isophorone diisocyanate, trimethylhexamethylene diisocyanate, norbornane diisocyanate, and dimers, trimers, and adducts of these isocyanates.

The above-mentioned component (C-1) may have a plurality of hydroxyl groups in a single molecule other than the active methylene group and/or active methine group. Such components may be used alone or two or more of such components may be used in combination. Additionally, those having an onium salt or an epoxy group in a single molecule are not the component (C-1).

In terms of the compatibility with other components, the component (C-1) to be contained in the coating composition containing a curable binder to be adopted in the invention is preferably polyester resin or acrylic resin.

The number average molecular weight of the component (C-1) is preferably in a range, for example, 300 to 10000. If the number average molecular weight is lower than 300, the hardness of the coating film to be obtained is decreased and the curability of the coating composition is insufficient in some cases or the solvent resistance, water resistance and weather resistance of the coating film may be deteriorated. If it exceeds 10000, the viscosity of the component (C-1) itself is increased and the amount of an organic solvent to be added to a coating composition diluted at the time of application may possible be increased. It is more preferably in a range of 500 to 3000.

The active hydrogen equivalent of the above-mentioned component (C-1) is preferably 40 to 2000 and more preferably 50 to 1000. If the active hydrogen equivalent is lower than 40, the compatibility with other components may possibly be decreased and the coating film to be obtained may become hard and brittle. If it exceeds 2000, the crosslinking density of the coating film to be obtained may be lowered and the physical properties and characteristics of the coating film may be deteriorated. The active hydrogen equivalent in this specification means molecular weight per one functional group in the case the methylene group is considered to be bi-functional and methine group to be mono-functional.

The coating composition containing the curable binder adopted in the invention further contains the Michael reaction catalyst (C-2). It is required to increase the acidity of methylene (methine) proton by two carbonyl groups neighboring to the methylene (methine) and to produce an enolate anion.

The Michael reaction catalyst (C-2) is preferable to contain an onium salt catalyst (c-1). The onium salt catalyst (c-1) is onium cation salt such as ammonium, pyridinium, sulfonium, and phosphonium. Addition of the above-mentioned onium salt catalyst (c-1) improves the curability of the coating composition containing the above-mentioned curable binder and therefore it is preferable. The cation portion of the onium salt catalyst (c-1) is not particularly limited and examples are tetraalkylammonium cation such as tetrabutylammonium cation, tetramethylammonium cation, tetrapropylammonium cation, tetrahexylammonium cation, tetraoctylammonium cation, tetradecylammonium cation, tetrahexadecylammonium cation, triethylhexylammonium cation, methyltrioctylammonium cation, cetyltrimethylammonium cation, and 2-chloroethyltrimethylammonium cation; trialkylaralkylammonium cation such as 2-hydroxyethylytrimethylammonium (choline) cation; alkylpyridinium cation such as methylpyridinium cation; tetraalkylphosphonium cation such as tetrabutylphosphonium cation; trialkylsulfonium cation such as trimethylsulfonium cation. Tetraalkylammonium cations and alkylpyridinium cations of which various types are made industrially available are preferable.

The anion portion of the above-mentioned onium salt catalyst (c-1) is not particularly limited and examples are halide anion, except fluorine anion, such as chloride anion, bromide anion, and iodide anion; anions derived from mono-basic carboxylic acids such as benzoic acid and salicylic acid; anions derived from poly-basic carboxylic acids such as maleic acid, phthalic acid, malonic acid, oxalic acid, succinic acid, and adipic acid; nitric acid anion; anions derived from sulfonic acids such as methanesulfonic acid, p-toluenesulfonic acid, and dodecylbenzenesulfonic acid; sulfuric acid anion; anions derived from acidic sulfate esters such as methosulfuric acid; nitrous acid anion; phosphoric acid anion; and anions derived from acidic phosphoric acid esters such as di-tert-butyl phosphate anion. In terms of the curability, the halide anions and carboxylate anions are preferable.

Examples of the onium salt catalyst (c-1) composed of the above-mentioned cation and anion are tetrabutylammonium chloride, tetraethylammonium bromide, diethyldibutylammonium chloride, octyltrimethylammonium bromide, dioctyldimethylammonium salicylate, benzyllauryldimethylammonium chloride, 2-hydroxyethyltrimethylammonium chloride, tetraethylphosphonium chloride, tetraethylphosphonium bromide, tetrabutylphosphonium chloride, and trimethylsulfonium chloride.

Further, as the above-mentioned onium salt catalyst (c-1), polymers obtained by copolymerization of acrylic monomers having onium salts (c-1-1) in a molecule and other radical polymerizable monomers (c-1-2) are also exemplified. Examples of the acrylic monomers having onium salts (c-1-1) are quaternized aminoalkyl (meth)acrylate such as 2-(methacryloyloxy)ethyltrimethylammonium chloride and 2-(methacryloyloxy)ethyltrimethylammonium bromide; quaternized aminoalkyl (meth)acrylamide such as methacryloylaminopropyltrimethylammonium chloride and methacryloylaminopropyltrimethylammonium bromide; quaternary ammonium (meth)acrylate such as tetrabutylammonium (meth)acrylate and trimethylbenzylammonium (meth)acrylate; quaternary phosphinoalkyl (meth)acrylate such as methacryloyloxyethyltrimethylammonium dimethylphosphate; and quaternary phosphonium (meth)acrylate such as trioctyl(4-vinylbenzyl)phosphonium chloride, tri-n-butyl(2-methacryloyloxyethyl)phosphonium chloride, 2-acid phosphoxyethylmethacrylate ditetrabutylammonium salt, tri-n-butylmethacryloyloxyethylphosphonium chloride, tri-n-octyl-4-vinylbenzylphosphonium chloride.

The other radical polymerizable monomers (c-1-2) are not particularly limited and examples are styrenes such as styrene and α-methylstyrene; acrylic acid esters such as methyl acrylate, ethyl acrylate, propyl acrylate, n-, iso-, and tert-butyl acrylate, 2-ethylhexyl acrylate, and lauryl acrylate; methacrylic acid esters such as methyl methacrylate, ethyl methacrylate, propyl methacrylate, n-, iso-, and tert-butyl methacrylate, 2-ethylhexyl methacrylate, and lauryl methacrylate; and amides such as acrylamide and methacrylamide.

As the onium salt catalyst (c-1), the above-mentioned compounds may be used alone or two or more of the optional components may be used in combination. The onium salt catalyst (c-1) is preferable to be added in an amount of 0.01% by weight as a lower limit and 10% by weight as an upper limit in the solids amount of the polymer components in the coating composition containing the curable binder. If the amount is lower than 0.01% by weight, sufficient curability cannot be obtained in some cases. Even if it exceeds 10% by weight, the effect is not so improved. The lower limit is more preferably 0.05% by weight and the upper limit is more preferably 5% by weight.

In the case the onium salt catalyst (c-1) is contained in the above-mentioned component (c), an epoxy group-containing component (c-2) is preferable to be added. Addition of the epoxy group-containing component (c-2) makes the component itself work as a reaction catalyst in combination with the onium salt catalyst (c-1).

As the epoxy group-containing component (c-2), for example, glycidyl compounds such as phenylglycidyl ethers, bisphenol type epoxy resin, reaction products of polyols with epichlorohydrine, glycidyl benzoate, and glycidyl (meth)acrylate; and alicyclic epoxy compounds such as 4-(3,4-epoxycyclohexyl)methoxycarbonyl-1,2-epoxycyclohexane and 3,4-epoxycyclohexanemethanol, and α-olefin epoxides such as epoxyhexadecane can be used.

Further, as the epoxy group-containing component (c-2), resins having epoxy groups in the side chains and obtained by copolymerization of acrylic monomers having epoxy groups in the molecule and/or acrylic monomer having five-member cyclic carbonate groups in the molecule with other acrylic monomers and/or non-acrylic monomers can be exemplified. Examples of such acrylic monomers having epoxy groups in the molecule are glycidyl ethers such as glycidyl (meth)acrylate, β-methylglycidyl (meth)acrylate, and 4-hydroxybutyl (meth)acrylate; and (meth)acrylate of 3,4-epoxycyclohexanemethanol.

Examples of above-mentioned other acrylic monomers and non-acrylic monomers are those not having epoxy group and specifically include acrylic monomers having active methylene groups and/or active methine groups and other acrylic monomers not having epoxy group, and non-acrylic monomers described for the above-mentioned component (C-1).

As the epoxy group-containing component (c-2), those obtained by addition reaction of polyols with epichlorohydrin described for the above-mentioned component (C-1) may also be used.

Further, as the epoxy group-containing component (c-2), an non-aqueous dispersion obtained by solution polymerization of a monomer mixture containing the above-mentioned acrylic monomers having epoxy groups, other acrylic monomers, and non-acrylic monomers according to a common method in a resin solution obtained by dissolving resin in an organic solvent can be exemplified. The above-mentioned organic solvent is not particularly limited and examples are well-known solvents such as aliphatic hydrocarbon type solvents, aromatic hydrocarbon solvents, petroleum type mixed solvents, alcohol type solvents, ether type solvents, ketone type solvents, and ester type solvents. The above-mentioned resin is not particularly limited and examples are acrylic resin obtained by copolymerization of acrylic monomers and/or non-acrylic monomer by a conventional method; polyester resins obtained by condensation polymerization of acid components such as polycarboxylic acids and alcohol components such as polyols by a conventional method; and alkyd resins modified by fatty acids or oil components.

In terms of the storage stability, the above-mentioned resins are preferably acrylic monomers not having epoxy group.

The non-aqueous dispersion may be obtained by solution polymerization of a monomer mixture containing the above-mentioned acrylic monomers having epoxy groups, other acrylic monomers, and non-acrylic monomers according to a common method in a resin solution obtained by dissolving the resin in the organic solvent.

The non-aqueous dispersion obtained in the above-mentioned method may further contain a plurality of groups such as active methylene group, active methine group, (meth)acrylate group, hydroxyl group, or the like in a single molecule other than the epoxy group.

The epoxy group-containing component (c-2) obtained in the above-mentioned method may further contain a plurality of groups such as active methylene group, active methine group, (meth)acrylate group, hydroxyl group, or the like in a single molecule other than the epoxy group. Such components may be used alone or two or more of them may be used in combination.

With respect to the coating composition containing the curable binder to be used in the invention, in the case the above-mentioned Michael reaction catalyst (C-2) contains the epoxy group-containing component (c-2) and the onium salt catalyst (c-1) simultaneously, the amount of the epoxy group-containing component (c-2) is preferably 1 to 30 times and more preferably 3 to 20 times as much as the equivalent of the onium salt catalyst (c-1). If it is lower than 1 equivalent, the concentration of epoxy groups, which is a catalyst aid, is so low as to result in insufficient promotion of curing reaction in some cases and if it exceeds 30 times as much, un-reacted epoxy groups remain even after the curing to possibly result in deterioration of durable quality such as chemical resistance, weather resistance and the like.

The above-mentioned clear coating composition may contain a UV absorbent, a hindered amine photostabilizer, an antioxidant, crosslinking resin particles, and a surface adjustment agent and the like other than the above-mentioned polymers. In the case the crosslinking resin particles are used, it is preferable to add them in an amount of 0.01% by weight as a lower limit and 10% by weight as an upper limit to the resin solids of the clear coating composition of the invention. The lower limit is more preferably 0.1% by weight and the upper limit is more preferably 5% by weight. If the addition amount of the crosslinking resin particles exceeds 10% by weight, the appearance of the coating film to be obtained is worsened and if it is less than 0.01% by weight, the rheology control effect cannot be obtained.

Although the above-mentioned clear coating composition of the invention may be a solvent-borne one or water-borne one, the solvent-borne one is more preferable. The organic solvent to be used in the solvent-borne coating composition is not particularly limited and examples are well known solvents such as aliphatic hydrocarbon type solvents, aromatic hydrocarbon solvents, petroleum type mixed solvents, alcohol type solvents, ether type solvents, ketone type solvents, and ester type solvents. The clear coating composition is preferably adjusted to have a viscosity in a range of 20 to 40 seconds at 20° C. measured by using Ford Cup #4 at the time of application. Adjustment of the viscosity in the range makes it possible to give excellent smoothness after application and properly prevent sagging.

The invention also provides a clear coating film formation method using the above-mentioned clear coating composition. The clear coating film formation method of the invention comprises a step (1) of applying the above-mentioned clear coating composition to an object to be coated, a step (2) of radiating energy beam from an approximately vertical face to the uncured coating film obtained in the step 1, and a step (3) of curing the coating film by heating the object subjected to the step 2.

The clear coating film formation method of the invention is capable of forming a coating film without causing sagging even in an approximately vertical face by carrying out the above-mentioned coating steps using the clear coating composition.

The above-mentioned step 1 is a step of applying the clear coating composition to an object to be coated. In the step 1, the method of applying the coating composition containing the curable binder is not particularly limited and may be brush coating, roller coating, air spraying, air-less spraying, immersion coating, and spread coating. Particularly in the case the object to be coated is an automotive body or automotive part, an air electrostatic spray coating method or rotary atomization electrostatic coating method is preferable. The coating composition containing the curable binder can properly be adjusted in the viscosity with an organic solvent or the like depending on the coating method. The coating thickness is not particularly limited and may properly be adjusted depending on the use of the object to be obtained.

As the method of applying the clear coating composition, specifically, coating methods using a rotary atomization type electrostatic coating apparatus so-called micro-micro bell or micro bell can be exemplified. The coating thickness of the clear coating composition in the step 1 is preferably in a range of 30 μm as a lower limit and 45 μm as an upper limit in dry film thickness.

The step 2 is a step of radiating energy beam to the uncured coating film obtained in the step 1 from an approximately vertical face. That is, energy beam is radiated particularly from the approximately vertical face where sagging easily occurs, so that the viscosity can be increased to suppress the sagging and improve the smoothness of the coating film and accordingly make the surface appearance of the coating film excellent.

Since the energy beam is radiated particularly from the approximately vertical face in the step 2, sagging is suppressed in a vertical face or approximately vertical face where sagging easily occurs and accordingly unevenness of the coating film surface is suppressed and surface appearance is improved. That the energy beam radiation from the approximately vertical face means execution of radiation to a horizontal face from the approximately vertical direction, however the radiation direction does not necessarily have to be precisely vertical and energy beam radiation may include radiation at an angle to an extent that the energy beam can be radiated sufficiently to the vertical face and approximately vertical face where sagging easily occurs. In the step 2, radiation is carried out at least from the approximately vertical direction and simultaneously radiation from the horizontal direction may be carried out.

The radiation of energy beam in the step 2 may be radiation of UV rays, sunlight, visible light, microwave, and electron beam. Among them, UV ray radiation is particularly preferable. The UV ray radiation may be carried out by using a carbon arc lamp, an electrode-less lamp, a mercury vapor lamp, a xenon lamp, a fluorescent lamp, an argon glow discharge or the like as a UV radiation source. Among them, an electrode-less lamp is preferable since it can evenly radiate UV rays to an object to be coated having a complicated structure.

Although the step 2 may be carried out immediately after the step 1 or after a preheat step is carried out following the step 1, it is more preferable to be carried out immediately after the step 1. The radiation intensity of the UV rays in the step 2 is preferably 200 to 2000 mJ/cm² and the radiation duration is preferably several seconds.

It is preferable to adjust the composition of the clear coating composition and the energy beam radiation conditions so as to keep the viscosity of the coating film in a range of 10000 to 50000 mPa·s after the step 2. If the viscosity of the coating film is lower than 10000 mPa·s, the sagging may not sufficiently be suppressed in some cases. If it exceeds 50000 mPa·s, the smoothness may be lost and the appearance becomes inferior like Chinese lemon skin.

The step 3 is a step of curing by heating the object to be coated after the step 2. The curing conditions in the step 3 differ depending on the composition of the coating composition to be used and may properly be set by a person skilled in the art and generally, the temperature is 80 to 200° C., preferably 100 to 180° C. and heating duration is preferably 10 to 40 minutes.

In the clear coating film formation method of the invention, a step (step 4) of radiating energy beam to the coating film subjected to the step 3 may be added. If the UV curable compound (U-1) having an unsaturated bond which are not reacted in the step 2 remains, the weather resistance may possibly be deteriorated and further increased crosslinking density can be obtained in the step 4 and therefore, the impact resistance of the coating film can be improved. The above-mentioned step 4 is for curing the UV curable compound (U-1) by radical polymerization reaction of the carbon-carbon unsaturated double bonds of the compound and practically the step is carried out by radiating UV rays using a carbon arc lamp, an electrode-less lamp, a mercury vapor lamp, a xenon lamp, a fluorescent lamp, an argon glow discharge or the like as a UV radiation source. Among them, an electrode-less lamp is preferable since it can evenly radiate UV rays to an object to be coated having a complicated structure.

An object to be coated which is adopted in the clear coating film formation method of the invention may be a variety of substrates, for example, metal molded products, plastic molded products, foamed bodies and the like and more particularly, metal molded products made of iron, aluminum, their alloys or the like and plastic molded products can be exemplified. The clear coating film formation method of the invention is a method particularly effective in the case the object to be coated has both approximately horizontal faces and approximately vertical faces. Accordingly, the method is preferably employed for a coating method of an object to be coated having a complicated shape just like an automotive body, an automotive part, or a special vehicle.

The clear coating film formation method of the invention is preferable to be adopted for a metal molded product which can be coated with cationic electrodeposition. The object to be coated is preferable to be subjected to chemical conversion in the surface. Further, the electrodeposited coating film may be formed on the object to be coated. As the electrocoating composition, although cationic and anionic ones can be used, the cationic electrocoating composition is preferable in terms of the corrosion prevention.

The clear coating film formation method of the invention may be a two-coat-one-bake coating method which is comprises forming an uncured base coating film by applying a base coating composition to an object to be coated; forming an uncured clear coating film on the uncured base coating film by applying the above-mentioned clear coating composition; and curing the uncured base and clear coating films by simultaneously heating them.

Further, based on the necessity, an intermediate coating film may be formed. An intermediate coating composition is used for formation of the intermediate coating film. The intermediate coating composition is not particularly limited and water-borne or organic solvent-borne coating compositions which are well known by a person skilled in the art can be exemplified.

The above-mentioned base coating composition is not particularly limited and it may contain coating film-formable resins, curing agents, color and extender pigments which are organic, inorganic or luster color, and so on. The type of the base coating composition is not particularly limited and, water-borne or organic solvent-borne one can be exemplified.

The above-mentioned base coating composition application method for the object to be coated is not particularly limited and spray coating and rotary atomization type coating can be exemplified and in terms of the appearance improvement, multistage coating by such methods or coating by combining such methods are preferable.

In the case coating is carried out by the two-coat-one-bake method, the coating thickness of the base coating composition is preferably in a range of 10 μm as a lower limit and 20 μm as an upper limit in dry film thickness.

In the clear coating film formation method of the invention, in the case the above-mentioned base coating composition is water-borne one, in order to obtain a coating film with good finishing, it is preferable to heat the uncured base coating film at 40 to 100° C. for 2 to 10 minutes before application of the clear coating composition.

Both uncured base coating film and uncured clear coating film formed by the above-mentioned method are simultaneously heated and cured to form a multilayer coating film. The heating temperature in the case of forming the multilayer coating film by the two-coat-one bake method is preferably 100° C. as a lower limit and 180° C. as an upper limit. The lower limit is more preferably 120° C. and the upper limit is more preferably 160° C. Although the thermosetting time is changed depending on the curing temperature, it is properly 10 to 30 minutes in the case the thermosetting is carried out in the above-mentioned temperature.

The clear coating composition and clear coating film formation method of the invention are capable of controlling sagging property and forming a coating film with satisfactory physical properties such as the appearance, weather resistance, and water resistance which are required for a clear coating film. That is, while the physical properties of the clear coating film being maintained as they are, the sagging can be improved and accordingly, an excellent clear coating film with good appearance properties can be formed.

### EXAMPLES

Hereinafter, the present invention will be explained in detail by way of Examples, but the present invention is not limited thereto. In Examples, without any particular remark, “part(s)” means “part(s) by weight” and “%” means “% by weight”.

### Production Example 1

### Production of Active Methylene Group-Containing Polyester

At first, 4,4′-isopropylidenedicyclohexanol 54.5 parts and dimethyl malonate 150 parts were fed to flask equipped with a condenser, a solvent recovery apparatus, a stirrer, a thermometer, and a nitrogen introduction tube and heated to 120 to 130° C. While methanol produced by ester interchange reaction being removed by distillation, the mixture was gradually heated to 150 to 180° C. On completion of removal of methanol 14.5 parts by distillation, the un-reacted dimethyl malonate 90 parts was recovered by distillation under reduced pressure. After the reaction mixture was cooled to about 50° C., butyl acetate 17.6 parts was added to obtain a polyester resin solution. The obtained polyester resin solution contained 85.7% by weight of solids and had a number average molecular weight 660 measured by GPC and active hydrogen equivalent 110.

### Production Example 2

### Production of Acrylic Resin for Dispersion

After butyl acetate 96 parts was fed to flask equipped with a condenser, a stirrer, a thermometer, a titration funnel, and a nitrogen introduction tube and heated to and kept at 110° C., a mixture containing hydroxyethyl acrylate as a hydrophilic monomer 34 parts, lauryl methacrylate as a hydrophobic monomer 34 parts, styrene and ethyl acrylate as other monomers 20 parts and 12 parts, respectively, and Kayaester-O as an initiator (tert-butylperoxy-2-ethylhexanoate, manufactured by Kayaku Akzo Corporation) 5 parts was dropwise added in 3 hours. After that, the mixture was stirred at 110° C. for 30 minutes and a solution obtained by dissolving Kayaester-O 0.5 part in butyl acetate 5 parts was drop wise added in 30 minutes. Further, the resulting mixture was stirred at 110° C. for 1 hour to obtain an acrylic resin solution. The acrylic resin solution contained 59.5% by weight of solids and had a number average molecular weight 7000 measured by GPC.

### Production Example 3

### Production of Epoxy Group-Containing Non-Aqueous Dispersion

After 61 parts of acrylic resin obtained in the production example 2 and butyl acetate 34 parts were fed to a flask equipped with similar apparatus and instruments to those of the flask used in the production example 2 and heated to and kept at 110° C., a mixture obtained by mixing Kayaester-O as an initiator (tert-butylperoxy-2-ethylhexanoate, manufactured by Kayaku Akzo Corporation) 0.7 part with a monomer mixture solution containing glycidyl methacrylate 35 parts and hydroxyethyl acrylate 35 parts was dropwise added in 3 hours. After that, the resulting mixture was stirred at 110° C. for 1 hour and then a solution obtained by dissolving Kayaester-O 0.1 part in butyl acetate 6 parts was added. The resulting mixture was further stirred at 110° C. for 1 hour to obtain a non-aqueous dispersion. The non-aqueous dispersion contained 63.0% by weight of solids and had an average particle diameter 215 nm measured by a Laser Scattering apparatus (DSL-700, manufactured by Otsuka Electronics Co., Ltd.). The viscosity measured at 20° C. by an R 115 model viscometer manufactured by Toki Sangyo Co., Ltd. was 490 mPa·s.

### Production Example 4

### Production of Quaternary Ammonium Salt-Containing Non-Aqueous Dispersion

After 61 parts of acrylic resin obtained in the production example 2 and n-butanol 34 parts were fed to a flask equipped with similar apparatus and instruments to those of the flask used in the production example 2 and heated to and kept at 120° C., a monomer mixture solution obtained by mixing Kayaester-O as an initiator (tert-butylperoxy-2-ethylhexanoate, manufactured by Kayaku Akzo Corporation) 0.7 part with a monomer mixture solution containing hydroxyethyl acrylate 30 parts, methyl methacrylate 10 parts MC-80H (2-(methacryloyloxy)ethyltrimethylammonium chloride, 80% aqueous solution, manufactured by Sanyo Chemical Industries, Ltd.) 9 parts was dropwise added in 3 hours. After that, the resulting mixture was stirred at 120° C. for 1 hour and then a solution obtained by dissolving Kayaester-O 0.1 part in butyl acetate 6 parts was added. The resulting mixture was further stirred at 120° C. for 1 hour to obtain a non-aqueous dispersion. The non-aqueous dispersion contained 62.1% by weight of solids and had an average particle diameter 151 nm measured by a Laser Scattering apparatus (DSL-700, manufactured by Otsuka Electronics Co., Ltd.). The viscosity measured at 20° C. by an R 115 model viscometer manufactured by Toki Sangyo Co., Ltd. was 390 mPa·s.

### Production Example 5

### Production of Epoxy Group-Containing Acrylic Resin

After butyl acetate 96 parts was fed to a flask equipped with similar apparatus and instruments to those of the flask used in the production example 2 and heated to and kept at 110° C., a mixture obtained by mixing Kayaester-O as an initiator (tert-butylperoxy-2-ethylhexanoate, manufactured by Kayaku Akzo Corporation) 10 parts with a monomer mixture solution containing glycidyl methacrylate 50 parts, hydroxyethyl acrylate 20 parts, and styrene 30 parts was dropwise added in 3 hours. After that, the resulting mixture was stirred at 110° C. for 30 minutes and then a solution obtained by dissolving Kayaester-O 0.5 part in butyl acetate 5 parts was dropwise added in 30 minutes. The resulting mixture was further stirred at 110° C. for 1 hour to obtain an acrylic resin solution. The obtained acrylic resin solution contained 53.6% by weight of solids and had a number average molecular weight 3000 measured by GPC.

### Comparative Production Example 1

A mixture obtained by mixing styrene 80 parts, n-butyl methacrylate 183 parts, 3,4-epoxycyclohexylmethylmethacrylate 137 parts, and Kayaester-O as an initiator 18 parts was dropwise added to a four-neck flask containing xylene 360 parts at 110° C. in 3 hours. After that, the mixture was aged at 110° C. for 0.5 hour. Further, Kayaester-O (tert-butylperoxy-2-ethylhexanoate) 2 parts and xylene 40 parts were mixed and dropwise added at 110° C. for 0.5 hour and the resulting mixture was aged for 1.5 hours. The obtained acrylic resin solution contained 50.0% by weight of non-volatile components and had a number average molecular weight about 4800 measured by GPC and an epoxy equivalent 286.

### Comparative Production Example 2

A mixture obtained by mixing 2-hydroxyethyl methacrylate

130 parts, methyl methacrylate 108 parts, styrene 76 parts, n-butyl acrylate 86 parts, and Kayaester-O as an initiator 18 parts was dropwise added to a four-neck flask containing xylene 360 parts at 110° C. in 3 hours. After that, the mixture was aged at 110° C. for 0.5 hour. Further, Kayaester-O (tert-butyl peroxy-2-ethylhexanoate) 2 parts and xylene 40 parts were mixed and dropwise added at 110° C. for 0.5 hour and the resulting mixture was aged for 1.5 hours. The obtained acrylic resin solution contained 49.8% by weight of non-volatile components and had a number average molecular weight about 5300 measured by GPC and a hydroxyl group equivalent 400.

### Example 1

An additive solution was obtained by mixing Tinuvin 384 (UV absorbent, manufactured by Ciba-Geigy Corp.) 2 parts, Tinuvin 292 (photostabilizer, manufactured by Ciba-Geigy Corp.) 2 parts, and an acrylic surface adjustment agent (solids 50% by weight, manufactured by Nippon Paint Co., Ltd.) 2 parts.

Mac Flow O-1810 Clear (tradename; acid epoxy-curable clear coating composition; manufactured by Nippon Paint Co., Ltd.) which is a commercialized clear coating composition 52 parts (based on solids) was mixed with A-TMM-3L (special acrylate, manufactured by Shin-Nakamura Chemical Co., Ltd.) 10 parts, LUCILIN TPO (photopolymerization initiator, manufactured by BASF Co.) 0.1 part, and Darocure 1173 (Ciba Specialty Chem. Inc.) 1 part.

The above-mentioned solution was mixed and stirred with the obtained additive solution to obtain a curable coating composition product. The obtained curable coating composition product was diluted with n-butyl acetate so as to have a viscosity of 30 seconds measured by using Ford Cup #4 (20° C.).

A dull-finished steel plate with a size of 300 mm length, 100 mm width, and 0.8 mm thickness subjected to zinc phosphate treatment was plated by electrodeposition with a dry film thickness of about 25 μm by using Power Top PU-50 (trade name; manufactured by Nippon Paint Co., Ltd.), which is a cationic electrocoating composition and further coated with Orga P-2 Sealer (trade name; manufactured by Nippon Paint Co., Ltd.) with a dry film thickness of about 40 μm by air spray coating and heated for thermosetting at 140° C. for 30 minutes. The coated test plate was further coated with a black color water-borne base coating composition with a dry film thickness of 16 μm by air spray coating and the coated test plate was heated for thermosetting at 140° C. for 30 minutes. Further, the test plate was polished with sand paper #1000 and degreased by wiping with petroleum benzine to obtain a coated test plate.

The coated test plate was set vertically and the coating composition produced in the above-mentioned manner was applied in a dry film thickness of about 40 μm to a 70 mm portion in the top side by air spray coating and immediately after that, UV radiation was carried out in conditions of using F 600 electrode-less lamp (240 W/cm) manufactured by Fusion UV System Japan Co., Ltd. with a bulb type of D bulb at a conveyer speed 4 m/min and lamp distance 10 cm. After that, while the coated test plate being set vertically, the test plate was heated at 140° C. for 30 minutes for thermosetting to obtain a test plate. The obtained test plate was subjected to the following evaluation methods to evaluate the coating film formed thereon.

### Example 2

A clear coating composition was produced, applied to a test plate, and subjected to evaluation methods in the same manner as Example 1, except that M-400 (a mixture of dipentaerythritol pentaacrylate and hexaacrylate, manufactured by Toagosei Co., Ltd.) 10 parts and LUCILIN TPO (photopolymerization initiator, manufactured by BASF Co.) 1 part were added to Mac Flow O-1810 Clear (trade name; acid epoxy curable clear coating composition; manufactured by Nippon Paint Co., Ltd.) 52 parts (based on solids) which is a commercialized clear coating composition.

### Example 3

After the active methylene group-containing polyester 30 parts obtained in Production example 1, the epoxy group-containing non-aqueous dispersion 20 parts obtained in Production example 3, the quaternary ammonium salt-containing non-aqueous dispersion 10 parts obtained in Production example 4, A-TMM-3L (special acrylate manufactured by Shin-Nakamura Chemical Co., Ltd.) 10 parts, Darocure 1173 (Ciba Specialty Chem. Inc.) 1 part, and LUCILIN TPO (photopolymerization initiator, manufactured by BASF Co.) 1 part were stirred and evenly mixed by a disper, the obtained additive solution was further added and stirred to obtain a curable coating composition product. The obtained curable coating composition product was diluted with n-butyl acetate so as to have a viscosity of 30 seconds measured by using Ford Cup #4 (20° C.). The obtained clear coating composition was applied to a test plate in the same manner as Example 1 and evaluated.

### Example 4

A coating composition was produced, applied to a test plate and evaluated in the same manner as Example 3, except that M-400 (a mixture of dipentaerythritol pentaacrylate and hexaacrylate, manufactured by Toagosei Co., Ltd.) 20 parts was used in place of A-TMM-3L (special acrylate, manufactured by Shin-Nakamura Chemical Co., Ltd.) 10 parts.

### Example 5

A coating composition was produced, applied to a test plate and evaluated in the same manner as Example 1, except that Mac Flow 0-1100 Clear (trade name; two-component urethane type clear coating composition; manufactured by Nippon Paint Co., Ltd.) was used in place of Mac Flow O-1800 Clear.

### Comparative Example 1

A coating composition was produced, applied to a test plate and evaluated in the same manner as Example 1, except that Superlac 0-100 Clear (trade name; clear coating composition containing acrylic resin and melamine resin; manufactured by Nippon Paint Co., Ltd.) was used in place of Mac Flow 0-1800 Clear.

### Comparative Example 2

As a clear coating composition, the resin solution 400 parts obtained in Comparative production example 1 (resin solids 200 parts), A-TMM-3L (special acrylate manufactured by Shin-Nakamura Chemical Co., Ltd.) 40 parts, Darocure 1173 (photopolymerization initiator, manufactured by Ciba Specialty Chem. Inc.) 1 part, and CI-2855 (photoacid generator, manufactured by Nippon Soda Co., Ltd.) 0.3 part were stirred and evenly mixed by a disper to obtain a curable coating composition product. The obtained curable coating composition product was diluted with n-butyl acetate so as to have a viscosity of 30 seconds measured by using Ford Cup #4 (20° C.). The obtained curable coating composition was adjusted in the specified heating conditions same in the Example 1 to obtain a test plate. The evaluation results are shown in Table 1.

### Comparative Example 3

As a clear coating composition, the resin solution 400 parts obtained in Comparative production example 2 (resin solids 200 parts), A-TMM-3L (special acrylate manufactured by Shin-Nakamura Chemical Co., Ltd.) 50 parts, Desmodur BL-3175 (a blocked polyisocyanate compound, manufactured by Sumitomo Bayer Urethane Co., Ltd.) 108 parts, dibutyltin dilaulate (a curing reaction catalyst) 1 part, and Darocure 1173 (a photopolymerization initiator, manufactured by Ciba Specialty Chem. Inc.) 1 part were stirred and evenly mixed by a disper to obtain a curable coating composition product. The obtained curable coating composition product was diluted with n-butyl acetate so as to have a viscosity of 30 seconds measured by using Ford Cup #4 (20° C.). The obtained curable coating composition was adjusted in the specified heating conditions same in the Example 1 to obtain a test plate. The evaluation results are shown in Table 1.

### Comparative Example 4

A coating composition was produced in the same manner as Example 4, except UV radiation was not carried out to obtain a test plate. The evaluation results are shown in Table 1.

### Evaluation Methods

(1) Viscosity measurement: The same operation was carried out as described above, except a tin plate was used in place of the above-mentioned coated test plate, and the coating film of the tin plate before UV radiation and the coating film of the tin plate after UV radiation were scratched and the viscosity of each coating film was measured at 25° C. by an E-type viscometer (VISCONIC EMD Viscometer, manufactured by Toki Sangyo Co., Ltd.).

(2) Sagging evaluation: How long distance (mm) the coating film applied to a 30 mm portion from a non-coated lower parts of each test plate flowed was practically measured after thermosetting.

(3) Pencil hardness: The pencil hardness was measured according to JIS K5400 8.4.2.

(4) Coating film appearance: The 60-degree gloss of the surface of each obtained cured coating film was measured by using a gloss-meter manufactured by Suga Test Instruments Co., Ltd. to evaluate the appearance. The evaluation standards are as follows.

⊚ 90 or higher;
◯ 80 to 90;
Δ 50 to 80; and
X 50 or lower.

(5) Hot water resistance test: After each obtained coating film was immersed in hot water at 40° C. for 10 days, the surface of the coating film was observed with eyes and evaluated according to the following standards.

⊚ Any change was scarcely observed:
Δ Traces were slightly observed: and
X Clear traces were observed.

(6) Weather resistance test: Each obtained cured coating film was subjected to a weathering test of 10 cycles each involving 24 hour-exposure and 24 hour-dewing by Eye Super UV Tester SUV-W 23 tester manufactured by Iwasaki Electric Co., Ltd. After that, the 60-degree gloss was measured to evaluate the appearance. The evaluation standards are as follows.

⊚ 90 or higher;
◯ 80 to 90;
Δ 50 to 80; and
X 50 or lower.

| | | | | | | | Compar- | Compar- | Compar- | Compar- |
|---|---|---|---|---|---|---|---|---|---|---|
| | | Example | Example | Example | Example | Example | ative | ative | ative | ative |
| | | 1 | 2 | 3 | 4 | 5 | Example 1 | Example 2 | Example 3 | Example 4 |
| Evalution | Coating film viscosity | 3350 | 3350 | 2850 | 3990 | 4150 | 3350 | 3300 | 2900 | 3900 |
| items | before UV radiation | | | | | | | | | |
| | (mPa · s) | | | | | | | | | |
| | Coating film viscosity | 25600 | 32200 | 28200 | 32000 | 27100 | 25200 | 25400 | 22100 | 3900 |
| | after UV radiation | | | | | | | | | |
| | (mPa · s) | | | | | | | | | |
| | Sagging (mm) | 0 | 0 | 0 | 0 | 0 | 0 | 0 | 12 | 15 |
| | Pencil hardness | F | F | F | H | F | F | F | F | H |
| | Coating film appearance | ⊚ | ⊚ | ⊚ | ⊚ | ⊚ | X | ⊚ | Δ | ⊚ |
| | (eye observation) | | | | | | | | | |
| | Hot water resistance test | ⊚ | ⊚ | ⊚ | ⊚ | ⊚ | ⊚ | X | ⊚ | ⊚ |
| | Weather resistance test | ⊚ | ⊚ | ⊚ | ⊚ | ⊚ | Δ | X | ⊚ | ⊚ |

From Table 1, it is made clear that the clear coating films obtained by the clear coating compositions of the invention were sufficiently suppressed in the sagging and provided with physical properties such as good appearance, water resistance and weather resistance required for the clear coating films. On the other hand, the clear coating compositions using melamine or an acid as a catalyst were found insufficient in the weather resistance and water resistance and thus inferior in the appearance.

### INDUSTRIAL APPLICABILITY

A clear coating composition and a clear coating film formation method of the invention are suitable for coating of an automotive body, an automotive part, and a special vehicle and accordingly, the invention makes it possible to form a clear coating film with suppressed sagging and excellent appearance and at the same time to maintain various physical properties required for the clear coating composition.

1. A clear coating composition containing a UV curable compound (U-1) having an unsaturated bond, a photopolymerization initiator (U-2), a half ester group-containing acrylic copolymer (A-1), and an epoxy group-containing acrylic copolymer (A-2).

2. A clear coating composition containing a UV curable compound (U-1) having an unsaturated bond, a photopolymerization initiator (U-2), a hydroxyl group-containing acrylic resin (B-1), and a polyisocyanate compound (B-2).

3. The clear coating composition according to claim 1,
wherein the UV curable compound (U-1) having an unsaturated bond is a compound having a (meth)acrylate group.

4. A clear coating film formation method comprising,
a step (1) of applying the clear coating composition according to claim 1 to an object to be coated,
a step (2) of radiating energy beam from an approximately vertical face to the uncured coating film obtained in the step 1, and
a step (3) of curing the coating film by heating the object subjected to the step 2.

5. A clear coating film formation method comprising,
a step (1) of applying a clear coating composition to an object to be coated,
a step (2) of radiating energy beam from an approximately vertical face to the uncured coating film obtained in the step 1, and
a step (3) of curing the coating film by heating the object subjected to the step 2,
wherein the clear coating composition contains a UV curable compound (U-1) having an unsaturated bond, a photopolymerization initiator (U-2), a component having an active methylene group and/or an active methine group (C-1), and a Michael reaction catalyst (C-2).

6. The clear coating film formation method according to claim 4,
wherein the UV curable compound (U-1) having an unsaturated bond is a compound having a (meth)acrylate group.

7. The clear coating composition according to claim 2,
wherein the UV curable compound (U-1) having an unsaturated bond is a compound having a (meth)acrylate group.

8. A clear coating film formation method comprising,
a step (1) of applying the clear coating composition according to claim 2 to an object to be coated,
a step (2) of radiating energy beam from an approximately vertical face to the uncured coating film obtained in the step 1, and
a step (3) of curing the coating film by heating the object subjected to the step 2.

9. A clear coating film formation method comprising,
a step (1) of applying the clear coating composition according to claim 3 to an object to be coated,
a step (2) of radiating energy beam from an approximately vertical face to the uncured coating film obtained in the step 1, and
a step (3) of curing the coating film by heating the object subjected to the step 2.

10. The clear coating film formation method according to claim 8,
wherein the UV curable compound (U-1) having an unsaturated bond is a compound having a (meth)acrylate group.

11. The clear coating film formation method according to claim 9,
wherein the UV curable compound (U-1) having an unsaturated bond is a compound having a (meth)acrylate group.

12. The clear coating film formation method according to claim 5,
wherein the UV curable compound (U-1) having an unsaturated bond is a compound having a (meth)acrylate group.
